(19) United States
(12) Patent Application Publication
(10) Pub. No.: US 2022/0055655 A1
(43) Pub. Date: Feb. 24, 2022

(54) POSITIONING AUTONOMOUS VEHICLES

(71) Applicant: Hewlett-Packard Development Company, L.P., Spring, TX (US)

(72) Inventors: Borja Navas Sanchez, Sant Cugat del Valles (ES); Ramon Viedma Ponce, Sant Cugat del Valles (ES); David Melero Cazorla, Sant Cugat del Valles (ES)

(73) Assignee: Hewlett-Packard Development Company, L.P., Spring, TX (US)

(21) Appl. No.: 17/417,213

(22) PCT Filed: Apr. 30, 2019
(86) PCT No.: PCT/US2019/029842

§ 371 Date: Jun. 22, 2021

(51) Int. Cl. B60W 60/00; B60W 30/10; B60W 40/10

(52) U.S. Cl. CPC B60W 60/001; B60W 40/10; B60W 30/10

(57) ABSTRACT

In an example, an autonomous vehicle comprises first and second sensors, wherein each of the first and second sensors is to acquire first and second position measurements for the autonomous vehicle. The autonomous vehicle may comprise a processor to compare the first and second position measurements and when the first and second position measurements are in agreement, determine a position of the autonomous vehicle by selecting the first position measurement, and when the first and second position measurements are not in agreement, determine the position of the autonomous vehicle by filtering the first and second position measurements with a stochastic filter.

### BACKGROUND

Sensors may be used to determine the position of autonomous vehicles while they are moving along a surface, for example to monitor how far along a route the vehicle is or whether the vehicle is maintaining an intended path.

### BRIEF DESCRIPTION OF THE DRAWINGS

Non-limiting examples will now be described with reference to the accompanying drawings, in which:

FIG. 1 shows a schematic representation of an example autonomous vehicle.

FIG. 2 shows a schematic representation of another example autonomous vehicle.

FIG. 3 shows a schematic flow chart of an example method.

FIG. 4 shows a schematic representation of an example machine readable medium and processor.

### DETAILED DESCRIPTION

Autonomous vehicles may be used, for example, as surface marking robots for drawing or printing lines on a surface by depositing print agent while moving along the surface. Such autonomous vehicles may be used in building and industrial applications, where high precision positioning, e.g. of lines produced by a surface marking robot, may be useful. Furthermore, autonomous vehicles such as, for example, a surface marking robot or a surface scanning robot, may be used in an indoor environment, or another environment where there may be a lack of reference objects which the autonomous vehicles can use to determine their position.

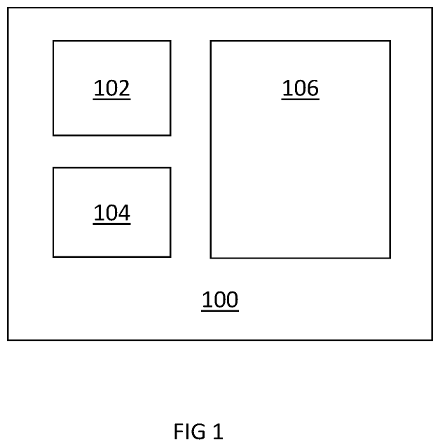

FIG. 1 shows an autonomous vehicle 100 comprising a first sensor 102 and a second sensor 104. In an example, the sensors may be mounted on a body of the vehicle 100 along with a motion control system such as a plurality of wheels connected to a motor, or any other suitable propulsion system. Each of the first and second sensors 102, 104 is to acquire first and second position measurements for the autonomous vehicle 100. The first sensor 102 may be, for example, an odometer; an optical sensor; an inertial sensor; a global positioning system such as an ultra wide band (UWB) system, an ultrasound system or a global navigation satellite system (GNSS); a camera, a LIDAR sensor, a time of flight (ToF) 3D camera, a stereo camera or any other type of suitable sensor. The second sensor 104 may be for example, an odometer; an optical sensor; an inertial sensor; a global positioning system such as an ultra wide band (UWB) system, an ultrasound system or a global navigation satellite system (GNSS); a camera, a LIDAR sensor, a time of flight (ToF) 3D camera, a stereo camera or any other type of suitable sensor. In some examples, first sensor 102 may, in general, provide a higher measurement accuracy than the second sensor 104. For example, the first sensor may have a higher possible measurement accuracy, or a higher inherent measurement resolution. The first sensor may be able to produce higher accuracy measurement data than the second sensor under most normal operating conditions. However, occasionally an error may occur in a position measurement derived from data from the first sensor. In some examples, the first and second sensors may be to continuously track the position of the autonomous vehicle. In some examples the first and second sensors may be to periodically track the position of the autonomous vehicle. The first and second sensors may be different sensor types.

The first sensor 102 may be an odometer, for example an odometer mounted on a motor of the autonomous vehicle 100 from which a relative position of the vehicle 100 can be determined based on the rate of rotation of the motor and a predetermined gear ratio between the motor and wheels of the autonomous vehicle 100 and a dead reckoning technique. In some examples, the first sensor may be an odometer with a measurement resolution of 1024×30 counts per wheel revolution.

The second sensor 104 may be an optical sensor, for example an optical sensor, positioned to face a surface the vehicle is travelling along, that tracks the displacement of features on the surface on which the autonomous vehicle is moving though a field of view, thereby providing an estimate of position on the surface. Such an optical sensor may provide lower resolution or lower accuracy position measurements under some measurement conditions than some other sensor types such as an odometer. An optical sensor directed tracking features on a surface may provide a relatively high accuracy measurement when used on a rough surface whereas on smoother surfaces the measurement accuracy will be reduced such that an optical sensor provides lower accuracy position measurements than e.g. an odometer. Such an optical sensor can be less accurate for determining position on certain types of surfaces where features are harder to detect, or are not themselves stationary (for example where there is a water or oil spill, or a glass surface, or a featureless surface). In some examples, the optical sensor may be an Optical Media Advanced Sensor (OMAS) or similar. In some examples, for example if the optical sensor is a ToF 3D camera, the measurement accuracy will depend on the range of detectable objects. That is, objects in close range may provide high resolution measurements but the measurement accuracy will drop the further away the objects are.

The autonomous vehicle 100 further comprises a processor 106. In some examples, the processor may be mounted on a body of the autonomous vehicle, in some examples the processor may be separate from the body of the autonomous vehicle but may be in communication with the first and second sensors 102, 104. The processor 106 is to compare the first and second position measurements, and when the first and second position measurements are in agreement, determine the position of the autonomous vehicle by selecting the first position measurement, and when the first and second position measurements are not in agreement, determine the position of the autonomous vehicle by filtering the first and second position measurements with a stochastic filter, for example a Kalman filter or an extended Kalman filter (EKF).

For example, if the first sensor 102 is an odometer and the second sensor 104 is an optical sensor, in use, the processor 106 compares data, i.e. position measurements, acquired for a particular position of the autonomous vehicle at a particular point in time, by the odometer and the optical sensor. Data acquired by the odometer in general provide a more accurate position measurement for the autonomous vehicle 100 as the measurement resolution and accuracy of the odometer is higher (i.e. the accuracy of measuring rotations of the motor and wheels). However, errors caused by wheel slippage or rocking of the base of the vehicle 100 can occur in the position determined from the odometer measurement. As the optical sensor is not prone to these types of errors, if the odometer and the optical sensor measurements do not agree, this could indicate that wheel slippage or rocking has occurred. Therefore, if the measurements agree, this indicates that no wheel slippage or rocking has occurred and the odometer position measurement data is used, as this will provide the most accurate indication of the position of the autonomous vehicle. However, if the measurements do not agree, the processor filters the first and second position measurements with a stochastic filter. In some examples, the autonomous vehicle may have other position sensors in addition to the first and second sensors 102, 104, for example, the autonomous vehicle may include an inertial sensor; a global positioning system such as an Ultra Wide Band (UWB) system, an ultrasound system or a global navigation satellite system (GNSS); a camera, a LIDAR sensor, or any other suitable position sensor. Measurements/data from these additional sensors may also be input to the stochastic filter to provide a resultant position measurement for the autonomous vehicle.

The system of FIG. 1 may therefore provide improved position determination for an autonomous vehicle.

In some examples, the stochastic filter has a weighting factor associated with each of the first and second sensors 102,104. For example, a weighting factor of a covariance matrix of the stochastic filter. The processor may dynamically reduce the weighting factor of one of the first and second sensors in response to a determination by the processor that there is an increased probability of error in sensor data acquired from that sensor. For example, from a comparison between the first and second sensor data, the processor may determine that the data from the first sensor has an increased probability of error. The processor may then reduce the relative weighting factor of the first sensor 102 relative to the weighting factor of the second sensor 104 in a covariance matrix of the stochastic filter. Dynamically adjusting the weighting factors in this way may improve the accuracy of the position determination for the autonomous vehicle. Further examples in relation to adjusting the weighting factors are set out below. Reducing a relative weighting factor means reducing the relative weighting. In other words, in practical terms, reducing a weighting factor may be achieved by decreasing that factor and/or by increasing a weighting factor associated with other sensors.

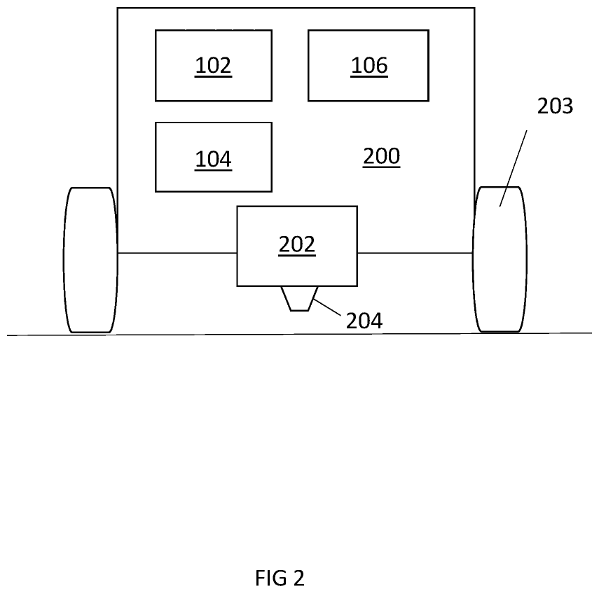

FIG. 2 shows an autonomous vehicle 200 having first and second sensors 102 and 104 respectively and a processor 106, as described previously in relation to FIG. 1 and a motion control system including wheels 203. The autonomous vehicle 200 also includes a print apparatus 202 comprising a print nozzle 204 mounted on a body of the vehicle, to deposit print material onto a surface as the autonomous vehicle travels along the surface.

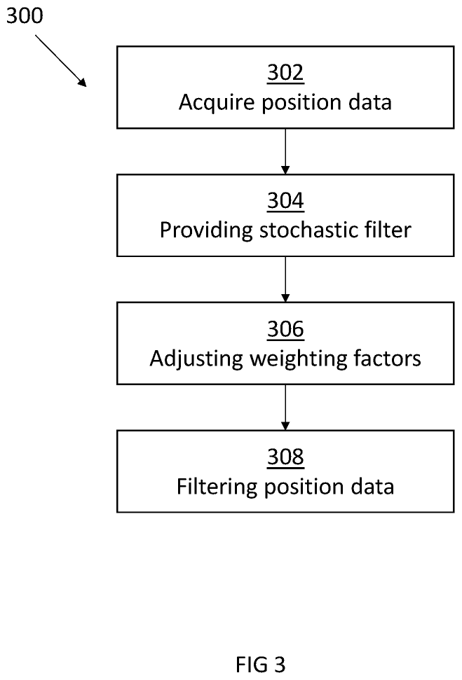

FIG. 3 shows a method 300, which may be a method for determining a position of an autonomous vehicle. The method 300 may be performed by an autonomous vehicle, such as the autonomous vehicle shown in FIG. 1 or 2.

Block 302 of the method 300 comprises acquiring, by each of a plurality of sensors in an autonomous vehicle, position data representing a position of the autonomous vehicle. The plurality of sensors may comprise any of an odometer; an optical sensor, an inertial sensor and a global positioning system such as an ultra wide band (UWB) system, an ultrasound system or a global navigation satellite system (GNSS). In some examples, the plurality of sensors may comprise a camera, a LIDAR sensor, or any other types of suitable position detection sensors. In some examples, the plurality of sensors may comprise more than one of a particular type of sensor.

Block 304 comprises providing a stochastic filter having a weighting factor associated with each sensor of the plurality of sensors. For example, the weighting factors may be weighting factors provided in a covariance matrix of the stochastic filter, which may be, for example, a Kalman filter or an extended Kalman filter.

Block 306 comprises dynamically adjusting the weighting factors associated with each sensor of the plurality of sensors. For example, block 306 may comprise determining that there is an increased probability of error in sensor data acquired from a particular sensor of the plurality of sensors; and in response reducing the weighting factor of the particular sensor relative to the weighting factor of another sensor of the plurality of sensors. In some examples, block 306 comprises updating the weighting factors by a processor in real time. In some examples, the weighting factors may initially have a baseline set of values which may be set, for example, during an initial calibration.

For example, the particular sensor may be an optical sensor to track measurement of surface features relative to the sensor as the autonomous vehicle moves over the surface (for example an optical media advance sensor—OMAS, or similar). Determining that there is an increased probability of error from the particular sensor may comprise determining that the rate of feature detection of the optical sensor is below a threshold. If the number of features detected by the optical sensor in a given time interval falls below a threshold, this indicates an increased likelihood that position measurements from the optical sensor have reduced accuracy. Therefore, reducing the weighting factor associated with the optical sensor may increase the accuracy of the overall position determination output by the stochastic filter. If it is determined at a later point that the number of features detected has increased above the threshold, the weighting factors may be readjusted to increase the weighting factor associated with the optical sensor.

In some examples, the particular sensor may be a global positioning system sensor such as an Ultra Wide Band (UWB) or Ultra Sound (US) sensor. Such a system may include a number of beacons that may be placed around an environment in which the autonomous vehicle is to move. For example, the beacons may be randomly positioned, or positioned in a predefined configuration around a particular indoor environment and the vehicle may be placed in position (for example in a position that corresponds to a zero point in a CAD file representing the path to be taken by the vehicle). Each of the beacons may then report a measured distance between themselves and the autonomous vehicle. The global position of the autonomous vehicle may then be calculated from measurements of the distance to the vehicle from each of the beacons.

Sensors based on a dead reckoning system for determining position such as a odometer or an optical sensor that tracks surface features may suffer from drift caused by signal integration, in which small errors in determined position accumulate as the cumulative number of sampled measurements increases, so that the determined position becomes less accurate overtime. ‘Global’ positioning system sensors such as UWB or US sensors or GNSS sensors are not dead reckoning based systems so do not suffer from the same drift errors. However, the measurement resolution of such systems may be lower than that of, for example odometers or optical sensors, which may be more accurate for a single measurement. In some examples, UWB or US position sensors may provide a position of an autonomous vehicle with an accuracy of ±2 to 10 cm. Combining position data from both of these sensors in a stochastic filter can therefore provide more accurate position information for the autonomous vehicle than using either of these systems alone. In some examples, the global positioning data may therefore be used to provide a signal drift stochastical correction. In some examples, determining that there is an increased probability of error in sensor data acquired from a particular sensor comprises detecting a drift in the data acquired by the particular sensor by comparing the data from the particular sensor with global positioning system sensor data.

In some examples, determining that there is an increased probability of error from the particular sensor comprises detecting an error in a beacon associated with a global position sensor. For example, comparing data from a beacon with data from other beacons in a set of beacons, or from another sensor, may indicate that one of the beacons has been knocked over or moved or is not functioning as expected for another reason. This may reduce the accuracy of data from the global position sensor. In this case, the weighting factors of the filter may be adjusted such that the global position sensor has a lower weighting in comparison with another sensor such as an inertial sensor or an odometer. If data from the set of beacons indicates that a knocked over beacon has been put back in its correct position, for example, the weighting factors may be readjusted in response.

Global positioning system sensors such as UWB, US or GNSS sensors may be inaccurate at determining a direction that the vehicle is facing (also referred to as ‘heading’). Therefore when the vehicle changes direction, position data from such sensors may become less accurate. Inertial sensors may be more accurate at determining a change in direction, but are also a dead reckoning based system as they measure a rate of change, and therefore may also suffer from drift errors. Therefore, in some examples, where the particular sensor is a global positioning system sensor such as an UWB or US system, determining that there is an increased probability of error in sensor data acquired from the particular sensor may comprise determining that the autonomous vehicle is changing direction, or is about to change direction. This may be determined, for example from data acquired from an inertial sensor, or a comparison of the autonomous vehicle's current position with an intended route or path of the vehicle, which may be determined, for example from route instructions for the vehicle, which may be generated by a state machine with some basic AI functionality, or other route data (for example, a CAD file or an image file) that defines the path to be marked out by the vehicle.

In some examples, the particular sensor is an odometer. Odometers may be prone to errors caused by rocking of a base of the vehicle relative to the wheels, or by wheel slippage, as in these cases the odometer will register a displacement (due to the wheels turning) even though the vehicle has not moved further along its path. In this case, determining that there is an increased probability of error from the particular sensor may comprise detecting that a wheel slippage or rocking of the vehicle has likely occurred by comparing the sensor data from an odometer with sensor data from another sensor, such as an optical sensor and detecting that a difference between position data from the odometer and position data from the other sensor is greater than a threshold magnitude.

In some examples the weighting factor of a particular sensor of the plurality of sensors may be reduced to zero, so that the position data from that sensor is not taken into account for the overall position determination until the weighting factors are readjusted. This may happen, for example, if a malfunction or error is detected for the particular sensor. In some examples, determining that there is an increased probability of error from the particular sensor comprises determining that communication with a particular sensor has been lost. For example, that communication with a UWB or US system has been lost. In that case the weighting factor of that sensor may be reduced to zero.

In some examples the weighting factor of a particular sensor may be reduced, so that the data from that sensor is given less weight, but not to zero, so that data from the particular sensor is still taken into account in the overall position determination. In some examples, dynamically adjusting the weighting factors may comprise increasing the weighting factor of a particular sensor relative to the weighting factors of another sensor of the plurality of sensors. In some examples, the weighting factors of each of the plurality of sensors may be dynamically adjusted. In some examples, the weighting factors may be continuously adjusted while the autonomous vehicle moves along a surface. In some examples, the weighting factors may be adjusted periodically during use of the autonomous vehicle.

Block 308 comprises filtering the position data from each sensor with the stochastic filter having the adjusted weighting values, for example a Kalman filter or an extended Kalman filter, to determine a position of the autonomous vehicle.

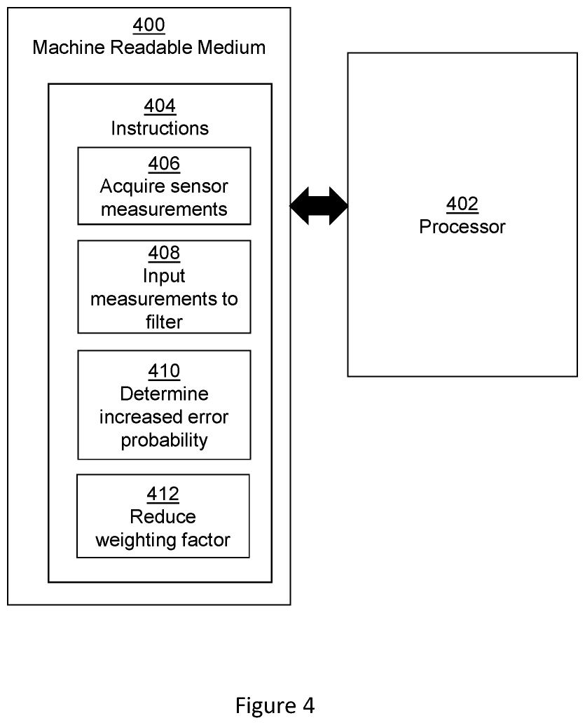

FIG. 4 shows a schematic representation of a tangible machine readable medium 400 comprising instructions 404 which when executed, may cause a processor 402 to perform example methods described herein, for example the method of FIG. 3. In some examples, the machine readable medium 400 may form part of an autonomous vehicle e.g. the autonomous vehicle 100 of FIG. 1 or the autonomous vehicle 200 of FIG. 2. In some examples, the machine readable medium 400 may be located externally to an autonomous vehicle and be in communication with the autonomous vehicle using a wireless communication system such as Wi-Fi, Bluetooth, or any suitable communication system.

The set of instructions 404 comprises instructions 406 to control a plurality of sensors to acquire sensor measurements representing a position of an autonomous vehicle. The instructions 404 further comprise instructions 408 to input the sensor measurements into a stochastic filter, wherein the stochastic filter includes a weighting factor for each of the sensor measurements based on which sensor acquired the sensor measurement. The instructions 404 also include instructions 410 to determine that there is an increased probability of error in sensor data acquired from a first sensor of the plurality of sensors; and, instructions 412 to, in response to determining that there is an increased probability of error in data acquired from the first sensor, reduce a relative weight of a first weighting factor associated with the first sensor.

In some examples, acquiring sensor measurements may comprise acquiring measurements from a plurality of sensors including an odometer and determining that there is an increased probability of error in sensor data from the odometer may comprise comparing the odometer sensor data with optical sensor data and detecting a difference between the odometer and optical sensor data greater than a threshold.

In some examples, acquiring sensor measurements may comprise acquiring measurements from a plurality of sensors including a global positioning system sensor and determining an increased probability of error in sensor data acquired from the global positioning system sensor comprises determining that the autonomous vehicle is changing direction and reducing a relative weight of the first weighting factor comprises reducing a weighting factor associated with the global positioning system sensor and increasing a weighting factor of an inertial sensor.

It shall be understood that some blocks in the flow charts can be realized using machine readable instructions, such as any combination of software, hardware, firmware or the like. Such machine-readable instructions may be included on a computer readable storage medium (including but is not limited to disc storage, CD-ROM, optical storage, etc.) having computer readable program codes therein or thereon.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. An autonomous vehicle comprising:
first and second sensors, wherein each of the first and second sensors is to acquire first and second position measurements for the autonomous vehicle; and
a processor to:
compare the first and second position measurements; and
when the first and second position measurements are in agreement, determine a position of the autonomous vehicle by selecting the first position measurement,
and when the first and second position measurements are not in agreement, determine the position of the autonomous vehicle by filtering the first and second position measurements with a stochastic filter.

2. An autonomous vehicle according to claim 1, wherein the first sensor provides a higher measurement accuracy than the second sensor.

3. An autonomous vehicle according to claim 2 wherein the first sensor is an odometer and/or the second sensor is an optical sensor.

4. An autonomous vehicle according to claim 1, wherein the stochastic filter has a weighting factor associated with each of the first and second sensors and wherein the processor is to dynamically reduce the relative weighting factor of one of the first and second sensors in response to a determination by the processor that there is an increased probability of error in sensor data acquired from that sensor.

5. An autonomous vehicle according to claim 1 further comprising a print apparatus comprising a print nozzle mounted on a body of the autonomous vehicle, to deposit print material onto a surface as the autonomous vehicle travels along the surface.

6. A method comprising:
acquiring, by each of a plurality of sensors in an autonomous vehicle, position data representing a position of the autonomous vehicle;
providing a stochastic filter having a weighting factor associated with each sensor of the plurality of sensors;
dynamically adjusting the weighting factors; and
filtering the position data from each sensor with the stochastic filter to determine a position of the autonomous vehicle.

7. A method according to claim 6 wherein dynamically adjusting the weighting factors comprises:
determining that there is an increased probability of error in sensor data acquired from a particular sensor of the plurality of sensors; and in response
reducing the relative weighting factor of the particular sensor relative to a weighting factor of another sensor of the plurality of sensors.

8. A method according to claim 7 wherein the particular sensor comprises an optical sensor and determining that there is an increased probability of error from the particular sensor comprises determining that a rate of feature detection of the optical sensor is below a threshold.

9. A method according to claim 7 wherein the particular sensor comprises an ultra wide band or ultrasound sensor and determining that there is an increased probability of error from the particular sensor comprises detecting an error in a beacon associated with the particular sensor.

10. A method according to claim 7 wherein the particular sensor is an odometer and determining that there is an increased probability of error from the particular sensor comprises detecting that position data from the odometer is not in agreement with position data from another sensor of the plurality of sensors.

11. A method according to claim 7 wherein the particular sensor is a global positioning system sensor and determining that there is an increased probability of error in sensor data acquired from the particular sensor comprises determining that the autonomous vehicle is changing direction.

12. A method according to claim 7 wherein determining that there is an increased probability of error in sensor data acquired from a particular sensor comprises detecting a drift in the sensor data acquired by the particular sensor by comparing the data from the particular sensor with global positioning system sensor data.

13. A tangible machine-readable medium comprising a set of instructions which, when executed by a processor cause the processor to:
control a plurality of sensors to acquire sensor measurements representing a position of an autonomous vehicle;
input the sensor measurements into a stochastic filter, wherein the stochastic filter includes a weighting factor for each of the sensor measurements based on which sensor acquired the sensor measurement;
determine that there is an increased probability of error in sensor data acquired from a first sensor of the plurality of sensors; and, in response
reduce a relative weight of a first weighting factor associated with the first sensor.

14. A tangible machine readable medium according to claim 13 wherein the first sensor is an odometer and the plurality of sensors further comprises an optical sensor; and
determining that there is an increased probability of error in sensor data from the first sensor comprises:
comparing position data acquired by the odometer with position data acquired by the optical sensor; and
detecting a difference between the acquired odometer data and the acquired optical sensor data greater than a threshold.

15. A tangible machine readable medium according to claim 13 wherein the first sensor is a global positioning system sensor and the plurality of sensors further comprises an inertial sensor; and
determining an increased probability of error in sensor data acquired from the first sensor comprises:
determining that the autonomous vehicle is changing direction; and
reducing a relative weight of the first weighting factor comprises reducing a weighting factor associated with the global positioning system sensor and increasing a weighting factor of an inertial sensor.
